(19) United States
(12) Patent Application Publication
(10) Pub. No.: US 2009/0008420 A1
(43) Pub. Date: Jan. 8, 2009

(54) Container, Especially Case, Box, Crate, Basket, Bag or the Like

(75) Inventors: Werner Zimmermann, Ottenbach (DE); Renate Zimmermann, Ottenbach (DE); Gerald Zimmermann, Ottenbach (DE)

Correspondence Address: GUDRUN E. HUCKETT DRAUDT, SCHUBERTSTR. 15A, WUPPERTAL, 42289, DE

(73) Assignees: ZAT AUTOMOBILTECHNIK GMBH, Goppingen (DE); SCALA DESIGN TECHNISCHE PRODUKTENTWICKLUNG GMBH, Boblingen (DE)

(21) Appl. No.: 12/166,344

(22) Filed: Jul. 2, 2008

(30) Foreign Application Priority Data
Jul. 2, 2007 (DE) 20 2007 009 642.9

(51) Int. Cl. B60R 7/00

(52) U.S. Cl. 224/282

(57) ABSTRACT

A container such as a case or box is provided with at least one fitting that has an adjustable arm provided with a connecting opening for receiving a connecting part of a motor vehicle. An insertion opening that is size-adjustable opens into the connecting opening. The connecting opening is defined by a hook of the adjustable arm and by a counter member that is adjustable relative to the hook. The hook is provided at the free end of a rod of the adjustable arm and the counter member is provided on a free end of a sleeve of the adjustable arm movable on the rod.

### BACKGROUND OF THE INVENTION

The invention concerns a container, preferably a case, a box, a crate, a basket, a bag or the like.

In order to transport containers, for example, boxes, in a motor vehicle, they are deposited e.g. in the trunk, on the back seat or even on the front passenger seat. This entails the problem that the container, for example, when braking hard, can slide accidentally. Business travelers often encounter the problem that they place their notebook on the front passenger seat so that, if needed, they have quick access to it. Such notebooks however slide very easily on the front passenger seat, in particular when the vehicle is braked hard or when the vehicle maneuvers a curve at high speed. Therefore, there is the danger that the notebook slides off the front passenger seat and is damaged.

On the other hand, child car seats are known that are placed onto the front passenger seat and are connected to connecting points provided on the front passenger seat.

The invention has the object to configure a container of the aforementioned kind in such a way that it can be deposited in the vehicle in a constructively simple way such that it cannot slide accidentally.

### SUMMARY OF THE INVENTION

As a solution to this object it is proposed, according to a first aspect of the invention, that the container according to the invention is provided with at least one fitting that has at least one adjustable arm provided with a connecting opening for a connecting part of a motor vehicle.

The fitting therefore has an adjustable arm that is provided with the connecting opening for the connecting part in the motor vehicle. The arm can be moved from a position of non-use into a position of use in which position of use the connection of the container to the connecting part provided on the motor vehicle is enabled. By means of the connecting opening the arm and thus the container can be secured to this connecting part. For example, a notebook can be placed without problems onto the front passenger seat without there being the risk that the notebook can fall off the front passenger seat even when high braking forces occur or the vehicle maneuvers a curve at high speed.

For example, the arm can be movable from the position of non-use linearly into the position of use. Advantageously, the movable arm is provided in the position of non-use in such a way on the container that it is positioned either within the container or in a recess on the exterior side of the container.

In a preferred embodiment, the arm is pivotably mounted on the container for pivoting from a position of non-use into the position of use. The fitting in this case is advantageously attached to the exterior side of the container. By means of this fitting it is possible to retrofit an already existing container with the adjustable arm.

In one embodiment according to another aspect of the invention the container according to the invention has at least one fitting that has at least one engaging part for a safety belt of a motor vehicle or the like.

Accordingly, the container has an engaging part for the safety belt of the container, and in this case, the safety belt, for example, on the front passenger seat is removed from the winding drum and inserted into the receptacle arranged laterally adjacent to the front passenger seat. The safety belt is then connected to the engaging part of the fitting. In this case, an additional connecting part of the motor vehicle for securing the container is not required.

In another embodiment, the container comprises the adjustable arm with connecting opening as well as the engaging part for the safety belt. In this case, the container according to the invention can be secured in a motor vehicle with connecting parts and without connecting parts.

Further features of the invention result from the additional claims, the description and the drawings.

### BRIEF DESCRIPTION OF THE DRAWINGS

The invention will be explained in more detail in the following with the aid of embodiments illustrated in the drawings. It is shown in:

FIG. 1 a perspective illustration of a container according to the invention with a holding part in its position of non-use;

FIG. 2 in detail and in a perspective illustration a part of the container according to FIG. 1 with the holding part in an outwardly pivoted position of use;

FIG. 3 a detail illustration of a portion of FIG. 2 with the holding part in its position of use;

FIG. 4 in an illustration in accordance with FIG. 1 a second embodiment of the container according to the invention with two holding parts pointing toward one another in their position of non-use;

FIG. 5 the embodiment according to FIG. 4 in an illustration in accordance with FIG. 3;

FIG. 6 in an enlarged illustration a portion of the container according to FIG. 5 with the holding parts in a release position and a locked position;

FIG. 7 a third embodiment of a container according to the invention in an illustration in accordance with FIG. 4 with an engaging part for connecting to the motor vehicle belt or the like;

FIG. 8

and

FIG. 9 the container according to FIG. 7 in an illustration according to FIG. 5 and FIG. 6, respectively;

FIG. 10

and

FIG. 11 a detail of the holding part according to FIG. 1 in an enlarged illustration in a locked position and a release position.

### DESCRIPTION OF PREFERRED EMBODIMENTS

The container 1 illustrated in the drawings can be a case, a crate, a box, a basket, a bag or the like that has at one side, preferably at a longitudinal side, one or two holding parts 3, 4 attached by means of a fitting 30. By means of the holding part or parts, the container, as will be explained in the following, can be connected to a securing part (not illustrated) such as an eye, a hook, a loop or the like, for example, of a motor vehicle seat or a trunk of a motor vehicle and locked on this securing part. Preferably, the container is a case for storing a laptop that can be placed by the driver onto the front passenger seat so that at any time while traveling important data can be accessed, for example, for meetings with a customer etc.

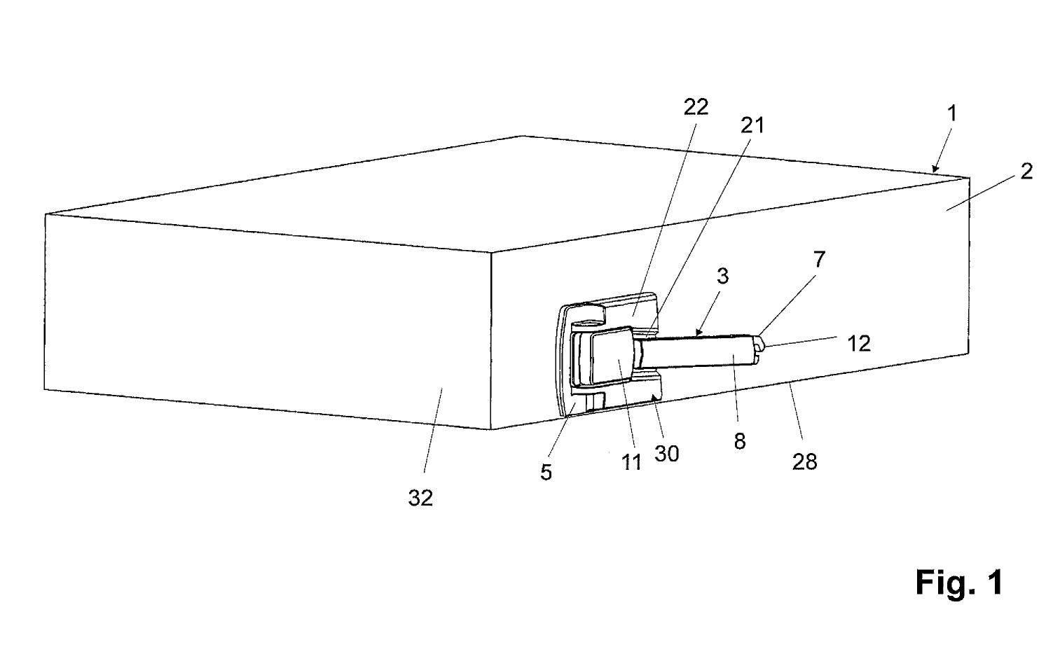

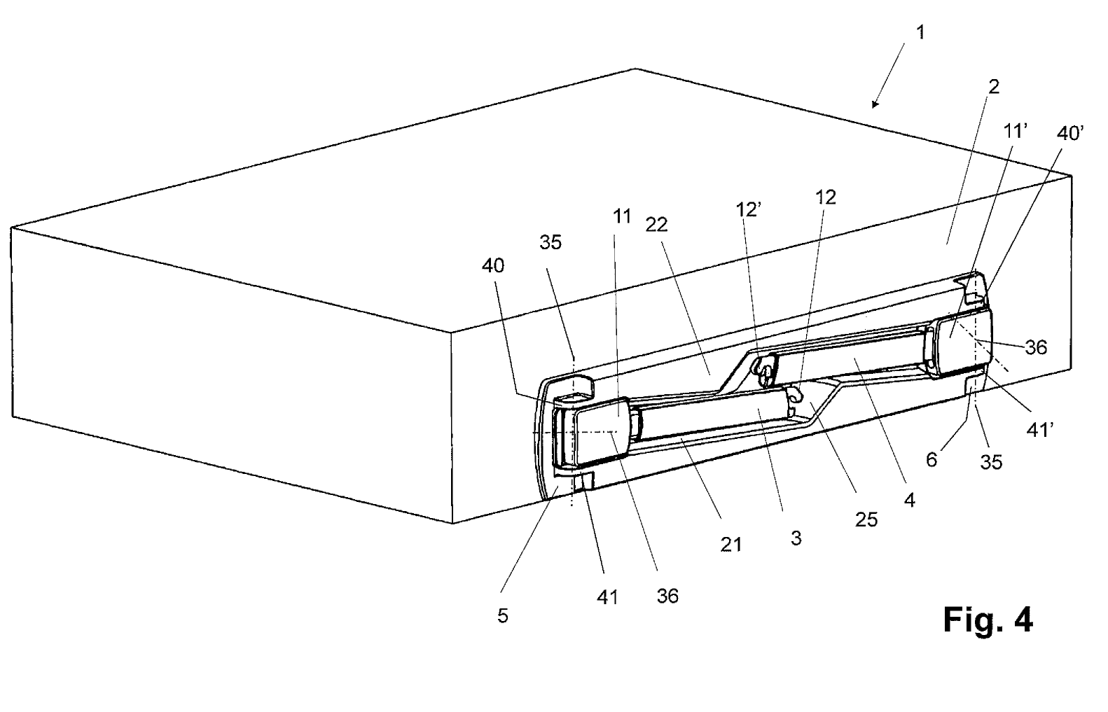

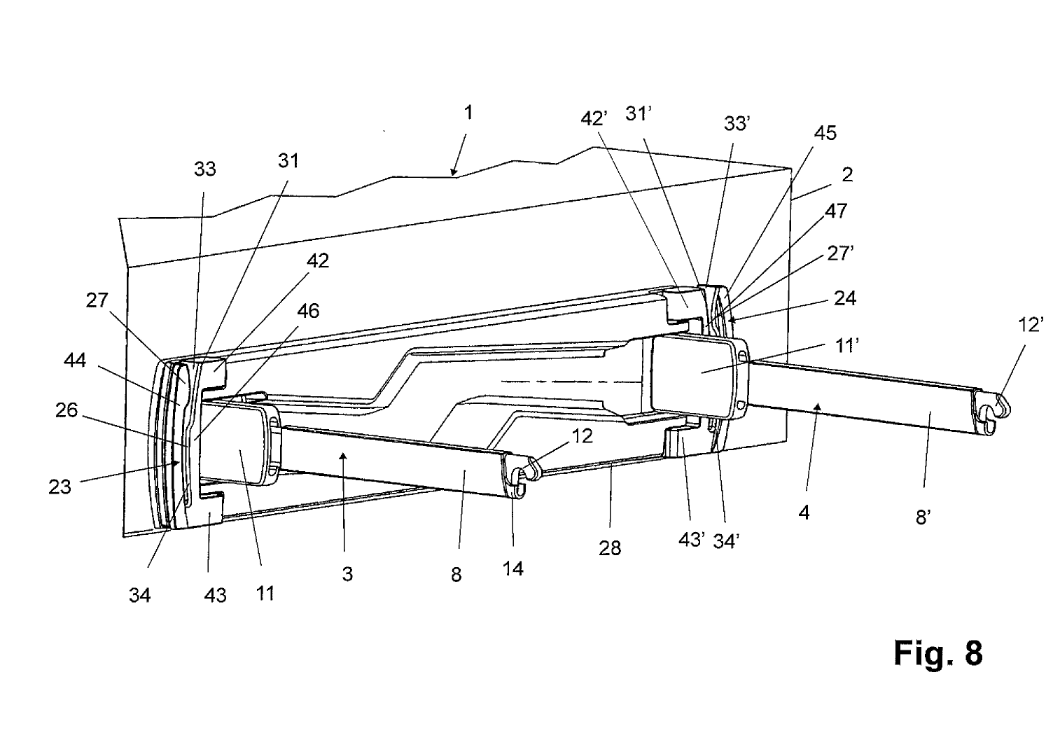

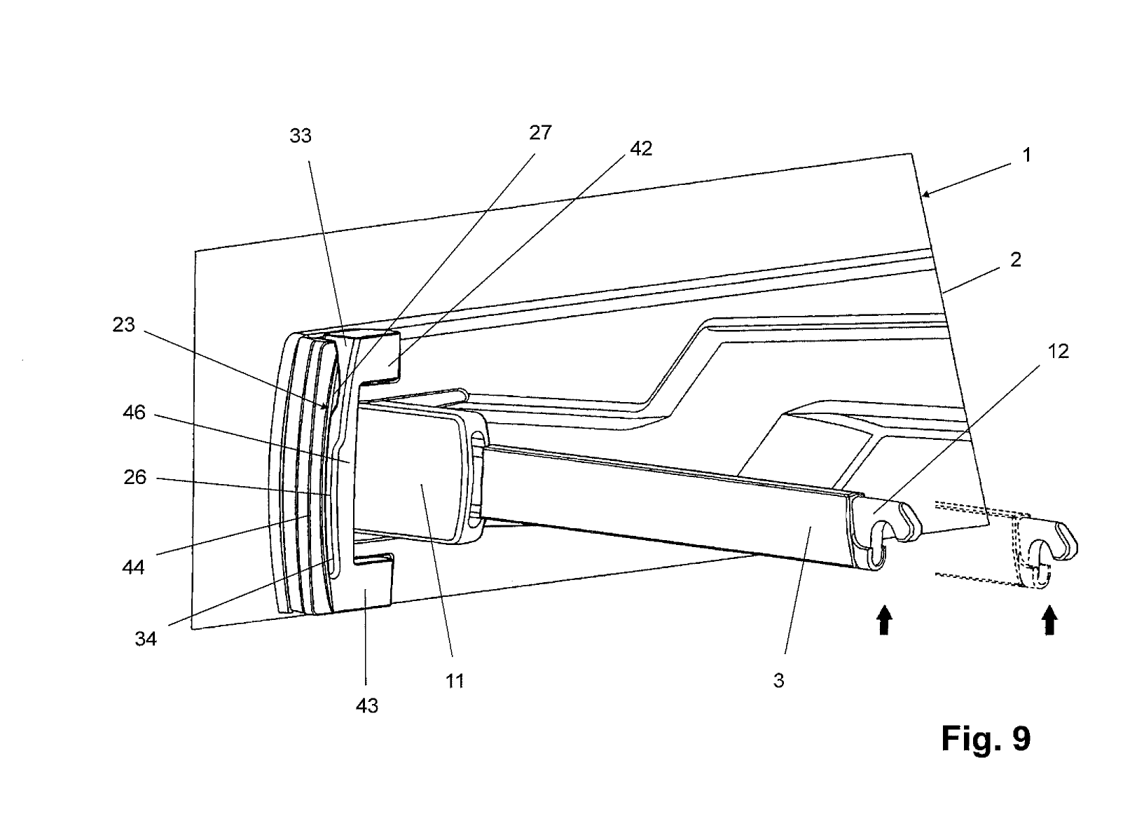

The fitting 30 is comprised preferably of a mounting and receiving plate 22 for one or two fitting parts 5, 6 to which one of the holding parts 3, 4 is pivotably attached. The fitting parts 5, 6 can also be formed as a monolithic part of the plate 22. The plate 22 is attached to the side 2 in such a way that its lower edge is approximately at the level of the bottom side of the case bottom 28. When the case has two holding parts (FIGS. 4 to 11), the ends of the plate 22 have substantially the same spacing from the narrow sides 32 of the case 1. The mounting plate 22 is a profiled plate having at one end (FIGS. 1 to 3) or both ends (FIGS. 4 through 11) the fitting parts 5, 6. They have only minimal thickness so that terminal receptacles are formed. A longitudinal groove 21 for receiving the holding parts 3, 4 adjoins the receptacles. In the longitudinal groove 21 the holding parts 3, 4 can be stored in a substantially recessed position in their folded-in position of non-use so that they are out of the way.

The case 1 according to FIGS. 1 to 3 has only one holding part 3 that is pivotably supported by the correlated fitting part 5 about a vertical axis 35.

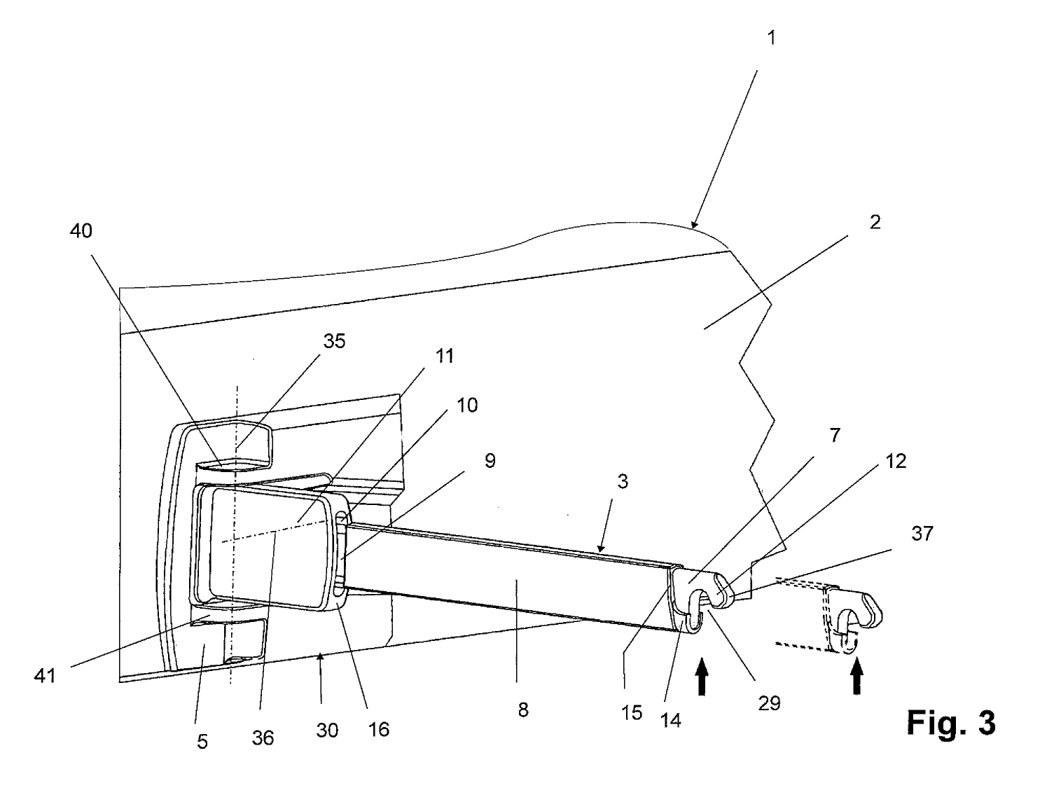

The holding part 3 is formed by a strip-shaped arm 7 with a sleeve 8 slidable thereon. With its first end 9 (FIG. 3) the arm 7 projects into an opening or a slot 10 provided in a pivot part 11 that is secured on the fitting part 5 so as to be pivotable about vertical axis 35. The fitting part 5 is substantially U-shaped and its legs point in FIGS. 1 to 3 to the right. Two narrow stays 40, 41 (FIG. 1) project into the receptacle 5, 6. The pivot part 11 projects into the space between the stays 40, 41, and is pivotably supported by the stays so as to pivot about axis 35. Within the pivot part 11 the arm 7 is pivotable about horizontal axis 36 to a limit extent. In this way, the arm 7 can be arranged in the position of non-use in the longitudinal groove 21 of the mounting plate 22. The longitudinal groove 21 extends at a slant downwardly in the direction toward the bottom 28 of the case 1. When the holding part 3 is pivoted into the position of non-use, it is first pivoted with the pivot part 11 about vertical axis 35. The pivot part 11 reaches the correlated recess in the mounting plate 22. When returning, the arm 7 is pivoted about horizontal axis 36 relative to the pivot part 11 so that it reaches the slantingly positioned longitudinal groove 21.

Preferably, the fitting 30 with fitting part 5 and mounting plate 22 is comprised of metal, for example, aluminum.

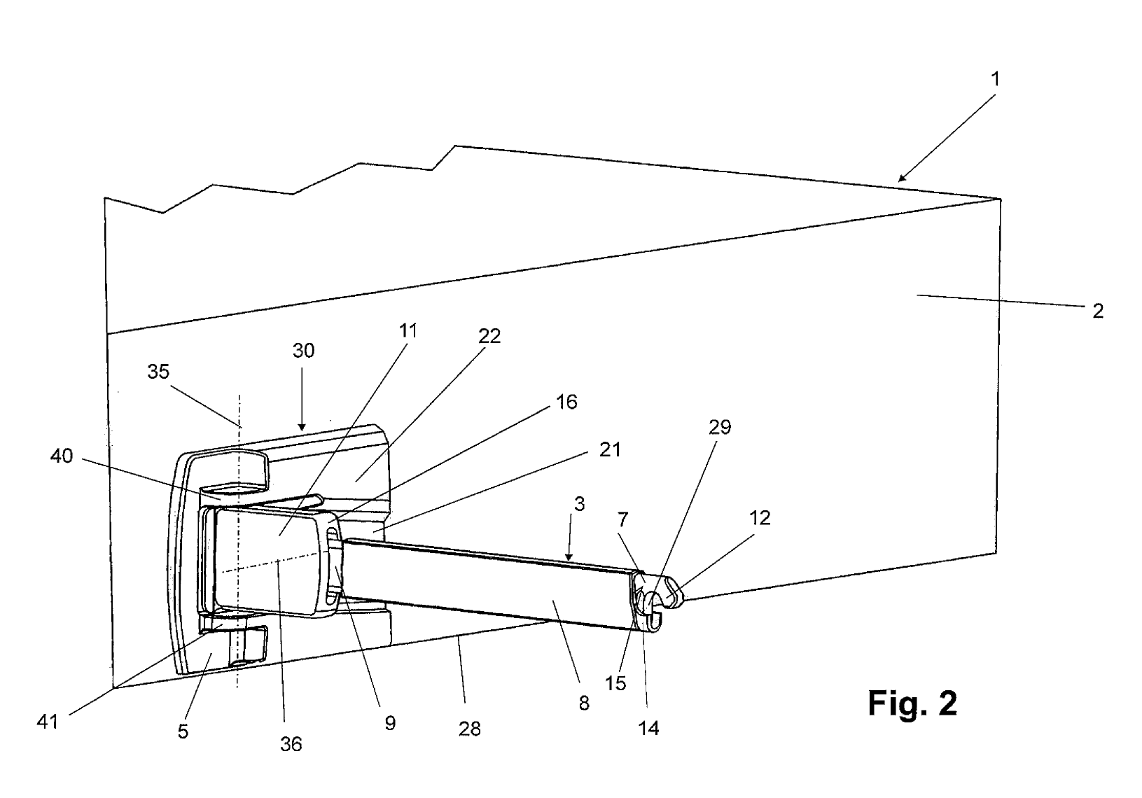

The free end 12 of the arm 7 is configured as a hook with a hook opening 29 that is downwardly delimited by a projection 14 as a counterpart (FIG. 2 and FIG. 3) that projects past the neighboring sleeve end 15. The projection 14 is configured as a U-shaped part that is open in the upward direction toward the hook 12 that adjoins the free end 15 of the sleeve, preferably is formed as a monolithic part thereof. In the locked position (dashed lines in FIG. 3) the hook 12 delimits with the projection 14 a hook opening 29 for the connecting part in such a way that it is safely secured in the opening against release.

The outer sides 37 of the hook 12 are slanted and form a ramp that facilitates insertion of the securing part provided at the motor vehicle.

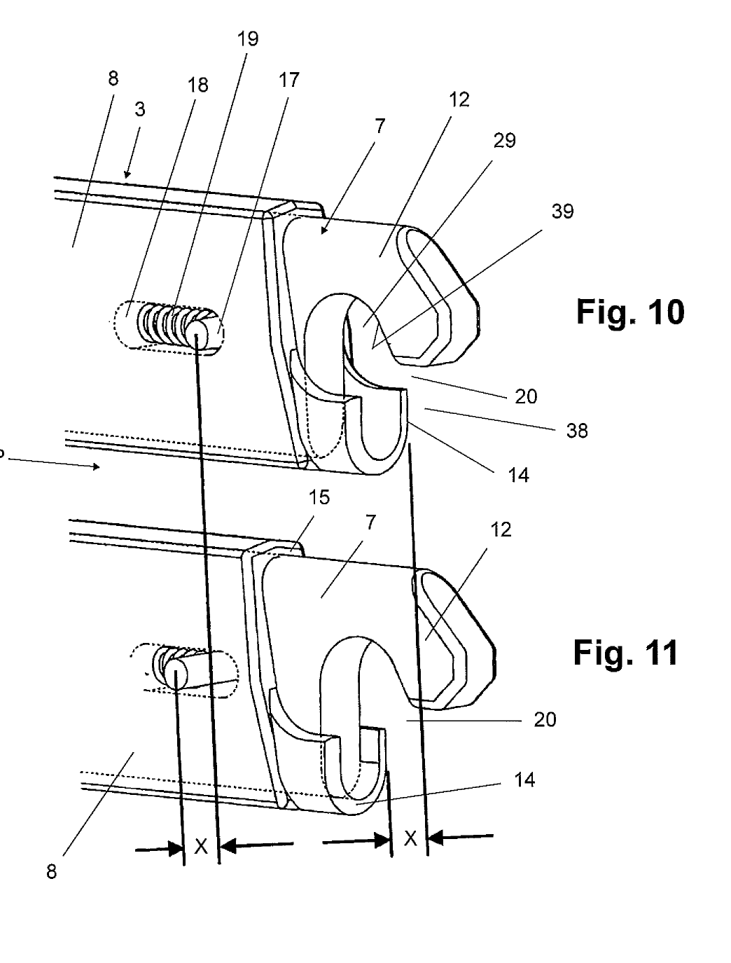

As shown in particular in FIGS. 2 and 3, the sleeve 8 surrounds the arm 7 almost over its entire length. Its end 9 facing away from the hook 12 in the securing position illustrated in FIGS. 2 and 10 has a minimum spacing from the neighboring opening edge 16 of the pivot part 11. This spacing is of such a size that the sleeve 8 can be pushed from the securing position into the release position according to FIGS. 3 and 11. As is shown in FIGS. 10 and 11, the sleeve 8 is provided at the inner side with a pin 17 extending transversely to the sliding direction; the pin engages a slotted hole 18 in the arm 7. A pressure spring 19 engages the pin 17 and is arranged in the slotted hole 18 and loads through the pin 17 the sleeve 8 in the direction of the securing position of the projection 14. The slotted hole 18, the pin 17 and the pressure spring 19 are covered by the sleeve 8. The pin 17 is forced by the action of the spring 19 against the rounded edge of the slotted hole 18 that is shown to the right in FIGS. 10, 11. Upon movement of the sleeve 8 from the locked position illustrated in FIG. 10 into the release position according to FIG. 11, the pin 17 is moved by the force of the sleeve 8 acting on it against the force of the pressure spring 19 in the direction of the arrow P to the left. The maximum travel is indicated in FIGS. 10 and 11 by X.

With the sleeve 8 retracted, the projection has been moved into a release position in which the hook opening 29 is open. An insertion opening 20 that opens into the hook opening 29 is therefore extended by the stroke X. In the release position, the hook part 3 can be released from the securing part provided on the motor vehicle.

Once released, the sleeve 8 is automatically returned by the force of the spring 19 into its locked position according to FIG. 10 in the direction P.

The use of the pressure spring 19 has the advantage that upon engaging the securing part of the motor vehicle, the projection 14 and thus the sleeve 8 can be returned without additional actuation. This process is facilitated in that the hook 12 projects past the projection 14 (FIG. 10). In this way, between hook 12 and projection 14 a receiving space 38 is formed that communicates by means of the insertion opening 20 with the hook opening 29.

For engagement, the securing part at the motor vehicle is within the receiving space 38. When the holding part 3 is forced against the securing part, the projection 14 and thus the sleeve 8 are moved back against the spring force. The hook 12 engages, during the engaging step, the securing part that therefore is unable to escape in the upward direction. The securing part reaches the slanted inner side 39 of the hook and the securing part is guided reliably thereon into the hook opening 29. As soon as the projection 14 is no longer acted on by the securing part, the projection 14 is returned by the pressure spring 19 into the securing position (FIG. 10). In this position, the width of the insertion opening 20 is so small that the securing part cannot slip out.

The embodiment according to FIGS. 4 to 6 differs from the afore described embodiment in that instead of the arm-shaped holding part 3 two holding parts 3 and 4 are provided that are supported by means of a pivot part 11, 11′ on the fitting part 5 and 6, respectively, so as to be folded in and out. The mounting plate 22 has terminal stays 40, 41; 40′, 41′ that project into the fitting parts 5, 6. In order to arrange both holding parts 3, 4 in a space-saving way in the longitudinal groove 21, the groove has a central widened portion 25 in which the free ends of the holding parts 3, 4 are arranged in the position of non-use one above the other (FIG. 4).

As in the previous disclosed embodiment, the holding parts 3 and 4 are supported pivotably about the axis 35 by means of a pivot part 11, 11′ arranged between the stays 40, 41; 40′, 41′, respectively. Within the pivot parts 11, 11′, the holding parts 3, 4 are pivotable about a horizontal axis 36, respectively.

The holding parts 3, 4 with the holding parts 5, 6 and the pivot parts 11, 11′ are identically designed but are arranged substantially mirror-symmetrical to one another.

In the position of non-use illustrated in FIG. 4, the holding parts 3, 4 are pointing toward one another wherein one holding part 3 is oriented at a slant downwardly away from the pivot part 11 and the other holding part 4 is oriented away from the pivot part 11′ at a slant upwardly. The free ends with the hooks 12, 12′ of the holding arms 3, 4 are in this position above one another in the widened portion 25 of the recess 21.

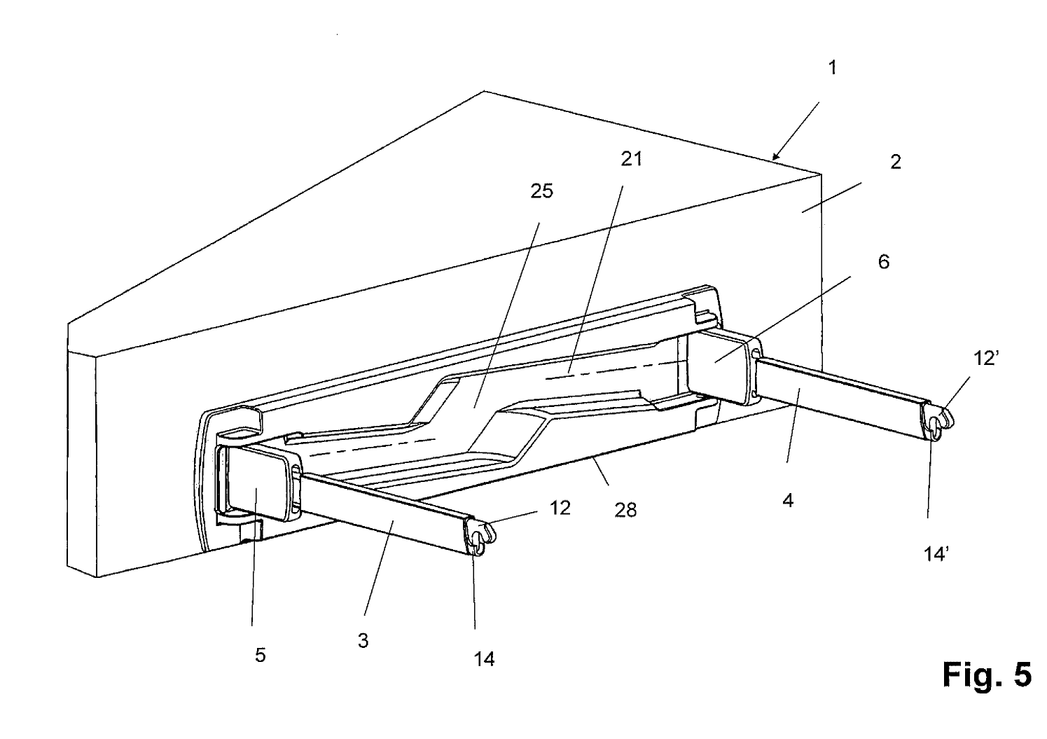

FIG. 5 shows the holding parts 3, 4 in the position of use in which they are perpendicularly folded outward in which position they can be hooked with their hooks 12, 12′ in connecting parts (not illustrated) such as eyes, counter hooks, rings, loops or the like, for example, in the area of a motor vehicle seat or in the trunk of a motor vehicle or the like. In this position, the connecting parts are secured properly in the hook openings 29 as described in connection with FIGS. 1 through 3. The holding parts 3, 4 are designed in the same way as in the preceding embodiments.

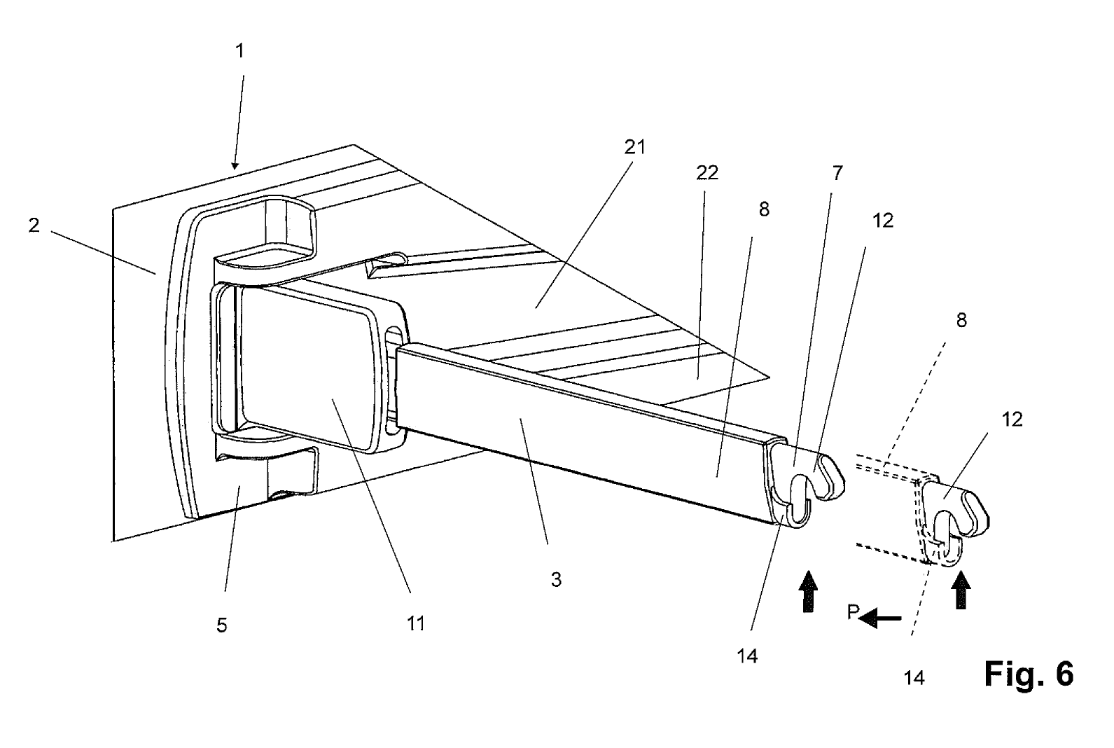

As shown in FIG. 6 with the aid of a holding part 3, the connecting parts can be released in a simple way from the holding part 3 in that the sleeve 8 is moved on the arm 7 in the direction of arrow P to the left in the drawing into the release position illustrated in solid lines.

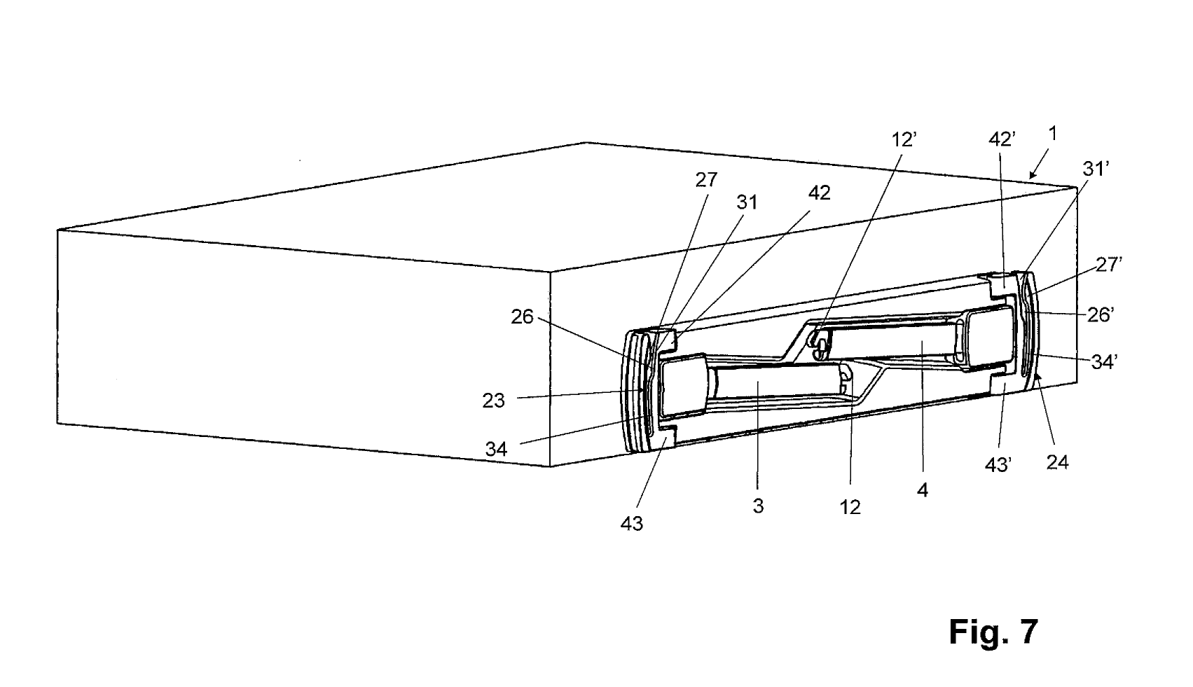

The embodiment according to FIGS. 7 through 9 differs from the afore described embodiment only in that on the fitting parts 5, 6 engagement brackets 23 and 24 are pivotably supported. They are U-shaped and engage with legs 42, 43; 42′, 43′ the stays 40, 41; 40′, 41′. The brackets 23 and 24 are identical and are comprised advantageously of metal. The brackets 23 and 24 each have a slightly arc-shaped outwardly curved bracket part 44, 45 that extends substantially across the entire height of the engagement brackets 23, 24. Between the bracket parts 44, 45 and a stay 46, 47 an insertion opening or insertion gap 26, 26′ is formed through which, for example, a safety belt of a motor vehicle seat or the like can be passed. In this way, the case 1 can be secured by means of the safety belt properly in a horizontal position on a vehicle seat.

Advantageously, the bracket parts 44, 45 in the area of their free ends are provided with a raised portion 27, 27′ that are positioned opposite an outer side 31, 31′ of the stays 46, 47 at a distance thereto. The raised portions 27, 27′ form with the outer side of the stays 46, 47 an insertion opening 33, 33′ for the belt, which insertion opening is V-shaped and widens outwardly for facilitating insertion of the belt. In the insertion direction of the belt behind these raised portions 27, 27′, the insertion gap 26, 26′ is narrower. This is achieved, for example, in that the outer side 31, 31′ in this area has a smaller spacing from the bracket part 44, 45 than in front of the raised portions 27, 27′.

The legs 42, 43; 42′, 43′ are pivotably supported about axis 35 (FIG. 2 and FIG. 3) on the stays 40, 41; 40′, 41′. When the vehicle is not provided with connecting parts, the holding parts 3, 4 are not pivoted out of their rest position (FIG. 7). Instead, the engagement brackets 23, 24 are pivoted about the axis 35 out of their recessed rest position by approximately 90 degrees outwardly into the position of use. It is then possible to comfortably thread the safety belt through the insertion openings 33, 33′ into the insertion gaps 26, 26′. Since they are widened in a direction opposite to the insertion direction of the belt, the safety belt can be inserted without problems. After the belt has been moved during the course of engagement into the insertion gaps 26, 26′ past the raised portions 27, 27′, the belt reaches the narrower section of the gap 26, 26′ in which it is secured properly. This narrow slot area extends approximately across half the height of the brackets 23 and 24 that corresponds approximately to the width of the belt. As a result of the raised portions 27, 27′ of the bracket parts 44, 45 it is ensured that the belt cannot slide out accidentally from the slot 26, 26′ because the raised portions 27, 27′ are positioned on top in the movement path of the belts.

In this embodiment the arms 3, 4 with their hooks 12, 12′ and the sleeves 8, 8′ are of the same design as described in the preceding embodiments.

The engagement brackets 23, 24 can also be designed to be springy. In this case, they can be attached to the mounting plate 22, for example, by clamps, rivets or screws. As a result of the springy configuration, the engagement bracket 23, 24 is elastically bent backward for threading the safety belt. The engagement bracket 23, 24 in this case can be comprised, for example, of spring steel.

What is claimed is:

1.-30. (canceled)

31. Container comprising at least one fitting that has at least one adjustable arm provided with a connecting opening for receiving a connecting part of a motor vehicle.

32. Container according to claim 31, wherein an insertion opening that is size-adjustable opens into the connecting opening.

33. Container according to claim 31, wherein the connecting opening is defined by a hook of the at least one adjustable arm and by a counter member that is adjustable relative to the hook.

34. Container according to claim 33, wherein the hook is provided at the free end of a rod of the at least one adjustable arm, wherein the hook is optionally embodied monolithically with the rod.

35. Container according to claim 34, wherein the counter member is provided on a free end of a sleeve of the at least one adjustable arm, wherein the counter member is optionally monolithically embodied with the sleeve.

36. Container according to claim 35, wherein the sleeve is arranged so as to be longitudinally slidable on the rod.

37. Container according to claim 36, wherein the counter member is a U-shaped projection of the sleeve.

38. Container according to claim 36, wherein the sleeve is arranged on the rod so as to be spring-loaded into a locked position of the connecting opening.

39. Container according to claim 38, wherein the sleeve has at least one stop for at least one pressure spring.

40. Container according to claim 39, wherein the stop is a pin.

41. Container according to claim 38, wherein the stop engages an opening provided in the rod, wherein the opening is optionally a slotted hole.

42. Container according to claim 41, wherein the at least one pressure spring is positioned in the opening of the rod.

43. Container according to claim 41, wherein the fitting comprises a pivot part and wherein the rod is secured in the pivot part.

44. Container according to claim 43, wherein the pivot part is pivotable about a vertical axis.

45. Container according to claim 43, wherein the rod is pivotably supported in the pivot part about a horizontal axis.

46. Container according to claim 43, wherein the fitting comprises a mounting plate provided with a recess, wherein the rod and the pivot part in a position of non-use are arranged in the recess of the mounting plate.

47. Container according to claim 46, wherein the fitting comprises a fitting part, wherein the pivot part is pivotably arranged on the fitting part.

48. Container according to claim 47, wherein the fitting part is substantially U-shaped.

49. Container according to claim 48, wherein the pivot part in a position of non-use is arranged between stays provided on the mounting plate.

50. Container according to claim 31, wherein at least two of said at least one adjustable arm are provided on opposite sides of the fitting and are pivotably supported so as to pivot in opposite directions.

51. Container comprising at least one fitting that has at least one engagement part for a safety belt of a motor vehicle.

52. Container according to claim 51 wherein the at least one engagement part is pivotable from a rest position into a position of use.

53. Container according to claim 52, wherein the at least one engagement part is pivotable about a vertical axis.

54. Container according to claim 51 wherein the at least one engagement part is U-shaped.

55. Container according to claim 51, wherein the fitting comprises a mounting plate, wherein the mounting plate has stays and the at least one engagement part has legs engaging the stays of the mounting plate.

56. Container according to claim 51 wherein the at least one engagement part has an engagement section that is curved across its length.

57. Container according to claim 56, wherein the at least one engagement section and an oppositely positioned stay of the at least one engagement part delimit a receptacle for the safety belt.

58. Container according to claim 57, wherein the engagement section has at a side facing the stay a terminal raised portion.

59. Container according to claim 58, wherein the raised portion forms with the stay of the at least one engagement part a widened insertion opening.

60. Container according to claim 59, wherein the receptacle narrows in an insertion direction behind the raised portion.
